(19) United States
(12) Patent Application Publication
(10) Pub. No.: US 2016/0094657 A1
(43) Pub. Date: Mar. 31, 2016

(54) EVENT-DRIVEN SYNCHRONIZATION IN SNMP MANAGED NETWORKS

(71) Applicant: Alcatel-Lucent Canada, Inc., Ottawa (CA)

(72) Inventors: Elvis Vieira, Ottawa (CA); Tibor Fasanga, Stittsville (CA); Kevin Ryan, Richmond (CA); Sanjeev Singal, Ottawa (CA); Joji Joseph, Ottawa (CA)

(21) Appl. No.: 14/502,254

(22) Filed: Sep. 30, 2014

(51) Int. Cl. H04L 29/08

(52) U.S. Cl. CPC H04L 67/1095; H04L 67/1097

(57) ABSTRACT

Various exemplary embodiments relate to a method for synchronizing data in a management database on a network node, the method carried out by an agent on the network, the method including storing an index associated with a relevant variable and a list of at least one indices associated with at least one dependency variables associated with the relevant variable; detecting a status change in the relevant variable; constructing an update notification including status information for the relevant variable and each of the at least one dependency variables; and sending the update notification.

### CROSS-REFERENCE TO RELATED APPLICATIONS

This application is related to co-pending application U.S. application Ser. No. ______ filed on the same date herewith, Attorney Docket Number ALC 3920, “Polling Based Synchronization in Managed Networks,” which is hereby incorporated by reference for all purposes as if fully set forth herein.

### TECHNICAL FIELD

Various exemplary embodiments disclosed herein relate generally to data synchronization in SNMP managed networks.

### BACKGROUND

Simple Network Management Protocol (SNMP) is a set of standards within in the Internet Protocol Suite standard for managing devices on IP networks as defined by the Internet Engineering Task Force (IETF). SNMP is used in network management systems to administratively monitor network-attached devices such as, for example, routers, switches, bridges, hubs, servers and server racks, workstations, printers, or any other network-accessible device on which an SNMP agent is installed. Typically, one or more “manager” administrative computers of monitors or manages a group of hosts or devices on a computer network, each of which executes a software “agent” which reports information on the status of the device via SNMP to the manager.

The larger and more complex the managed network, the greater the demand on the managers' resources. This may greatly impact the scalability of the management solution if the system has insufficient computational resources when data synchronization occurs. In view of the foregoing, it would be desirable to reduce the resources needed to synchronize data in SNMP managed networks.

### SUMMARY

In light of the present need for decreasing the resources needed to synchronize data in SNMP managed networks, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method for synchronizing data in a management database on a network node, the method carried out by an agent on the network, the method including storing an index associated with a relevant variable and a list of at least one indices associated with at least one dependency variables associated with the relevant variable; detecting a status change in the relevant variable; constructing an update notification including status information for the relevant variable and each of the at least one dependency variables; and sending the update notification. Some embodiments also include receiving a confirmation message in response to the update notification. In alternative embodiments, the confirmation includes a size limitation. In some embodiments the confirmation includes an SNMP message, and in some embodiments the update notification includes an SNMP message.

In some alternative embodiments the method includes designating a timeout period. Some embodiments include determining that the timeout period has expired; determining that no confirmation has been received in response to the update notification; and re-sending the update notification. Alternative embodiments include determining a size of the update notification; determining the size of the update notification is greater than a size limitation; and prior to sending the update notification, modifying the update notification so the size of the update notification is less than the size limitation. Some alternative embodiments include determining a priority limit; receiving a request to reduce update notifications; constructing a second update notification including status information for the relevant variable and each of the at least one dependency variables; calculating a priority of the second update notification; comparing the priority of the second update notification with the priority limit; determining the priority of the second update is greater than the priority limit; and sending a notification of the second update. Some embodiments include determining the request to reduce update notifications includes an update value for the priority limit; and storing the new priority limit before the step of comparing the priority. In some alternative embodiments the method includes receiving a request to stop update notifications; constructing one or more additional update notifications; receiving an update request; and sending the one or more additional update notifications.

Various exemplary embodiments relate to a method for managing the synchronization of data in a management database on a network node, the method including receiving an update notification; determining a buffer size; calculating an amount of buffer remaining; and sending an update notification confirmation, where the update notification confirmation includes the amount of buffer remaining. Some embodiments also include determining the amount of buffer remaining is greater than a soft threshold amount and less than a hard threshold amount; and sending a request to reduce update notifications for one or more variables. Some alternative embodiments include re-calculating the amount of buffer remaining; determining the amount of buffer remaining is less than a soft threshold amount; and sending a request to resume update notifications for the one or more variables. Alternative embodiments include determining a threshold delay timeout; and prior to sending a request to resume update notifications, determining the threshold delay timeout has expired.

In various alternative embodiments, the recalculated amount of buffer remaining is determined to be less than the previously calculated amount of buffer remaining minus the maximum size of a UDP header and a granularity divided by the number of messages in the buffer. Some embodiments include determining the amount of buffer remaining is greater than a hard threshold amount; sending a notification to stop update notifications; and requesting a second update notification. Some alternative embodiments include re-calculating the amount of buffer remaining; determining the amount of buffer remaining is less than a soft threshold amount; and sending a notification to resume update notifications. Some embodiments include determining at least one dependent variable associated with a relevant variable; and sending a message including an index associated with the relevant variable and a list of at least one indices associated with each of the at least one dependent variable. In alternative embodiments, the message including an index includes an SNMP message.

Various exemplary embodiments relate to a method for synchronizing data in a management database on a network node, the method carried out by an agent on the network, the method including storing an index associated with a relevant variable and a list of at least one indices associated with at least one dependency variables associated with the relevant variable; detecting a status change in the relevant variable; and sending an update notification including status information for the relevant variable and each of the at least one dependency variables. Some embodiments include receiving a confirmation message in response to the update notification.

Various exemplary embodiments relate to a method for synchronizing data in a management database on a network node, the method carried out by a manager on the network, the method including determining at least one dependent variable associated with a relevant variable; and sending a message including an index associated with the relevant variable and a list of at least one indices associated with each of the at least one dependent variable.

Various exemplary embodiments relate to a method for managing the synchronization of data in a management database on a network node, the method including receiving an update notification; determining a buffer size; calculating an amount of buffer remaining; determining the amount of buffer remaining is greater than a soft threshold amount and less than a hard threshold amount; and sending a request to reduce update notifications for one or more variables. Some embodiments include re-calculating the amount of buffer remaining; determining the amount of buffer remaining is less than a soft threshold amount; and sending a request to resume update notifications for the one or more variables.

Various exemplary embodiments relate to a method for managing the synchronization of data in a management database on a network node, the method including receiving a first update notification; determining a buffer size; calculating an amount of buffer remaining; determining the amount of buffer remaining is greater than a hard threshold amount, sending a notification to stop update notifications; and requesting a second update notification. Some embodiments include re-calculating the amount of buffer remaining; determining the amount of buffer remaining is less than a soft threshold amount; and sending a notification to resume update notifications.

Various exemplary embodiments relate to a method for managing the synchronization of data in a management database on a network node, the method including determining a priority limit; sending a notification of a first update; receiving a request to reduce update notifications; calculating a priority of a second update; comparing the priority of the second update with the priority limit; determining the priority of the second update is greater than the priority limit; and sending a notification of the second update. Some embodiments include determining the request to reduce update notifications includes an update value for the priority limit; and storing the new priority limit before the step of comparing the priority.

Various exemplary embodiments relate to a method for managing the synchronization of data in a management database on a network node, the method including sending a notification of a first update; receiving a request to stop update notifications; compiling one or more updates; receiving a request for an additional update; and sending a notification of the one or more compiled updates.

It should be apparent that, in this manner, various exemplary embodiments enable reducing the resources needed to synchronize data in SNMP managed networks.

### BRIEF DESCRIPTION OF THE DRAWINGS

In order to better understand various exemplary embodiments, reference is made to the accompanying drawings, wherein:

FIG. 1 illustrates an exemplary network management system in which synchronization is performed;

FIG. 2 illustrates an exemplary structure of a syncTable in a Synchronization management information base;

FIG. 3 illustrates an exemplary structure of a syncDepTable in a Synchronization Dependency management information base;

FIG. 4 illustrates an exemplary directed graph of dependencies corresponding to the combined entries of an exemplary syncTable and syncDepTable;

FIG. 5 illustrates an exemplary minimum spanning tree demonstrating the effect of an update on other objects in a network environment;

FIG. 6 illustrates an exemplary graph of an update corresponding to the update illustrated by the minimum spanning tree;

FIG. 7 illustrates the data structure of an exemplary manager event buffer;

FIG. 8 illustrates an exemplary system in which congestion control messages may be exchanged between a manager and an agent; and

FIG. 9 illustrates a graph demonstrating buffer capacity during an exemplary period.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein. Further, while various exemplary embodiments are described with regard to data synchronization in managed networks, it will be understood that the techniques and arrangements described herein may be implemented to facilitate data synchronization in other types of systems that implement multiple types of data processing or data structure.

Configuration and status data of components managed in SNMP are exposed as variables organized hierarchically. Devices can be remotely managed and configured by reporting and remote modification of these variables. Hierarchies and other metadata such as variable types and descriptions are described by Management Information Bases (MIBs). Because in SNMP managed objects or devices are represented by variables defined in an SNMP MIB, the two concepts of managed devices and variables are used somewhat interchangeably herein. When an object is in a SNMP PDU (defined herein below), the conventional notation “varbind” is used to represent the object ID (OID) and its corresponding ASN.1 value. MIBs are typically but not necessarily used to manage devices using SNMP, but may also manage devices using other network management models. MIBs enable extensibility in SNMP and other network management models—to describe the hierarchical structure and variables of each managed device or group of devices, MIBs use a hierarchical namespace of object identifiers (OIDs), each of which identifies a variable corresponding to a status and/or configuration that can be read and/or set via SNMP. MIBs typically use notation defined by the Structure of Management Information Version 2 specification (SMIv2, RFC 2578), a subset of ASN.1.

SNMP uses an application layer protocol for communication between managers and agents. Specifically, seven protocol data units (PDUs) are used to communicate modifications and status updates (five original to the protocol, and two added in later versions). Each SNMP PDU includes the following fields: IP header, UDP header, version, community, PDU-type, request-id, error-status, error-index, and variable bindings. The seven PDUs are “GetRequest,” (manager-to-agent request to retrieve the value of a variable or list of variables; returns a Response with current values); “SetRequest” (manager-to-agent request to change the value of a variable or list of variables; returns a Response with current/new values for the variables); “GetNextRequest” (manager-to-agent request to discover available variables and their values; returns a Response with variable binding for the next variable in the MIB; the entire MIB of an agent can be walked by iterative application of GetNextRequest starting at OID 0, or rows of a table can be read by specifying column OIDs in the variable bindings of the request); “GetBulkRequest” (manager-to-agent request for multiple iterations of GetNextRequest; returns a Response with multiple variable bindings derived by iteratively walking rows following the variable binding or bindings in the request) (added in later versions); “Response” (returns variable bindings and acknowledgement from agent to manager for GetRequest, SetRequest, GetNextRequest, GetBulkRequest and InformRequest, including error reporting (error-status and error-index fields)); “Trap” (asynchronous unsolicited notification sent from agent to manager to notify of significant events); and “InformRequest” (acknowledged asynchronous notification, from manager to manager or agent to manager; added in later versions because SNMP commonly runs over UDP where delivery is not assured and dropped packets are not reported and delivery of a Trap is not guaranteed; sometimes referred to herein simply as an “Inform”).

Communication takes place in the Application Layer of the Internet Protocol Suite (Layer 7 of the OSI model), where an SNMP agent receives requests on UDP port 161 (the manager may send requests to an agent from any available source port to port 161), and the agent response will be sent back to the source port on the manager. Notifications such as Traps and InformRequests are received by the manager on port 162; the agent may generate notifications from any available port.

The SNMP manager's database of managed objects must be kept in synchronization with the MIBs in remote SNMP agents. Depending on the amount of data to be updated, keeping data for a network element synchronized in an MIB database can be extremely demanding in terms of computational resources, and in fact is typically one of the most resource consuming tasks in a network managed by a SNMP system. For example, when a manager detects some modification in the MIB of a remote SNMP agent, sometimes it has to get the new value of the modified object and all the values of any other objects correlated with it, for instance through a “GetNextRequest” or “GetBulkRequest”—if the modified object has many dependencies and/or there are many modified objects at once, resources can become constrained. This problem is particularly acute in cases where all the MIB tables from the remote SNMP agent must be retrieved, such as when a node reboots or is updated; sequences of tasks to update all the objects in the manager's database will be triggered leading to high CPU and memory consumption.

In conventional systems, agents will continue to send messages continuously, and if a manager becomes overwhelmed and cannot keep up with processing all incoming update messages, it will simply let the messages drop, and may request additional information when additional resources become available. In some instances where updates have been lost and a manager requests updates, an agent may send only information updated since the manager stopped processing incoming messages, but in some instances where the agent has lost track of the updates, data regarding all settings for that agent may need to be sent so that the manager has a complete status for the agent. In the best case, updates must be sent twice; in the worst case, all variables for each updating agent must be transmitted, rather than only updated variables. There are some middle cases, such as, for example, where Trap messages are numbered and a manager can determine that there are gaps between the index of the last Trap received and processed, and the index of an incoming Trap. In any case, however, update messages will be sent more often when a manager becomes too busy to process incoming messages.

As noted above, in a network management system implemented using SNMP, one or more managers may manage a device or group of devices on a network (or object or group of objects, particularly in the case of virtualization), each of which includes an agent which reports information on the status of the device to the manager(s). Conventionally, each agent maintains a local MIB, and a manager maintains a database or repository of the MIBs of the agents it manages. Thus, the management database must be synchronized as agent devices are updated, added, deleted, or rebooted.

In order to more efficiently manage data synchronization in managed networks, functionality may be split between two MIBs. The first MIB may be called Synchronization MIB and may be used to control the events in an event-driven synchronization, such as selecting which MIB variables an agent monitors for updates in order to send update events to the manager. The second MIB may be called Synchronization Dependency MIB, and may be used to establish dependency relations between variables in table columns or table rows, so that when an event occurs an agent may send the updated variable and all variables that depend upon it so long as the dependent variables were updated at the same time as, or any time afterwards, the variable was updated.

This split synchronization mechanism enables manager event buffer overflow, managing event buffer size when implemented as a UDP buffer. Event buffer overflow may be prevented proactively (rather than re-actively), which in turn will prevent notification discards.

The effects of these synchronization improvements include reducing the number of messages exchanged and SNMP objects managed during the synchronization of a manager's database with an agent's MIB, which may be a major bottleneck to keeping both manager and agent synchronized. As a result, manager and agent resource consumption may be reduced by avoiding unnecessary processing which consumes memory and CPU resources. As such, SNMP management becomes more scalable because a greater number of, and more complex, network elements may be managed using the same amount of resources.

Two types of synchronization may be described, polling based synchronization and event-driven synchronization. With polling based synchronization, the SNMP manager may be responsible for interrogating the agent every time a new update is needed. With event-driven synchronization, the agent may send an event to the manager every time a new update happens. Event-driven synchronization generally requires fewer networking and processing resources, at least in part because during polling based synchronization these resources are used to interrogate the agent even when there is no update. However, event-driven synchronization can result in over-utilization in manager resources when large numbers of update messages arrive in a short period of time. Thus, each method may be preferable under different conditions depending at least upon the network configuration, performance requirements, and current status. For example, rebooting and updating of devices, particularly network equipment, may be a scenario in which polling based synchronization is typically preferred, because instead of having a burst of notifications which may overwhelm manager resources (as a large set of managed objects are being updated), the manager may selectively synchronize using polling based synchronization. After a reboot and/or upgrade is complete, the synchronization may be switched to event-driven synchronization.

Generally, although it is possible to switch from one type of synchronization to another when network management system resources are becoming critical, it is preferable to pre-emptively adjust the system to accommodate a variable number of messages with the most efficient use of system resources, and to change communication parameters such as synchronization type and the number of messages before system resources become constrained and/or wasted. Particularly in a system where there are a large number of devices or set of devices sending updates to a manager, there are a finite number of messages that can be processed by the manager at a time. Typically large numbers of updates happen for relatively short periods of time, or bursts. As noted, conventional practice is for managers to let incoming messages drop, and request additional information when capacity is available. It would be preferable if congestion may be handled pre-emptively between managers and agents by a busy manager sending a response message to the node informing the node how busy or backed up the manager is, and the node sending updates at a lower rate until the manager backlog is cleared.

Similarly, even with event-driven synchronization, because updates at an agent device may be complicated, a message may be sent with a notification about a change in which not all details of the change are given, or there may be objects dependent on an update whose status may be unknown after the update. In these cases, a request may be sent from the manager to the agent requesting additional detail for specific objects and properties designated by the agent as relevant. In order to minimize the number of messages that are sent in such exchanges, particularly where the number of messages is already high, it may be preferable that all information relevant to the manager be sent from the agent in the first message or messages sent informing the manager of an update, without the manager sending a request for additional information.

Referring now to the drawings, in which like numerals refer to like components or steps, there are disclosed broad aspects of various exemplary embodiments.

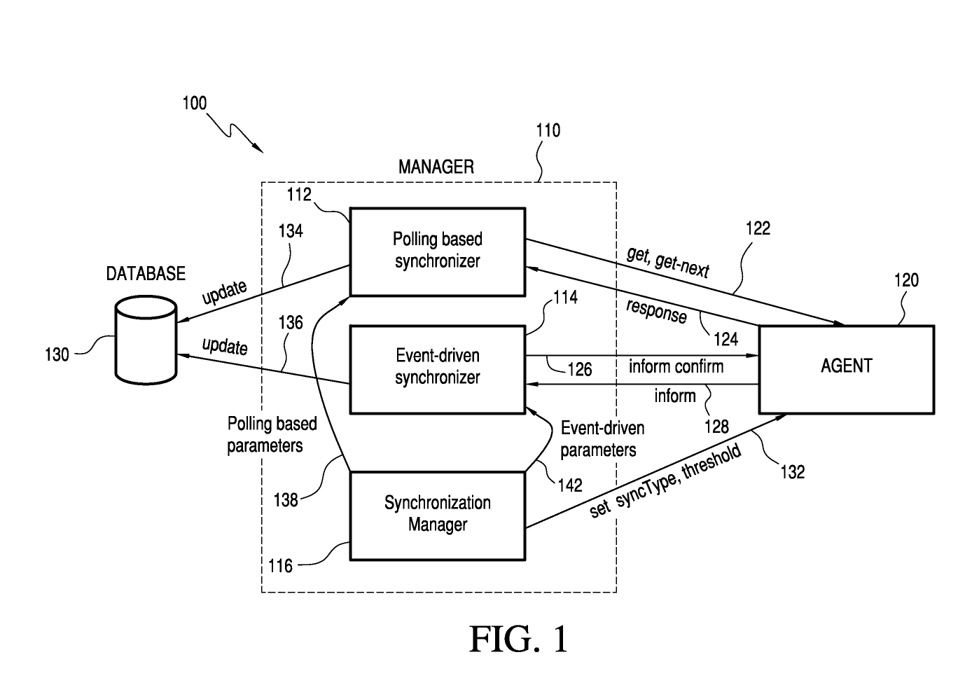

FIG. 1 illustrates an exemplary and generic system 100 in which a synchronization is performed between a manager 110, an agent 120, and a database 130. The arrangement of system 100 may be arranged differently than shown in FIG. 1—for example, manager 110, agent 120, and database 130 may be located on the same system, or may be located on two or more systems. Further, there may be multiple agents, managers, and databases in a system 100. Typically, a manager 110 may be responsible for keeping the database 130 updated, an agent 120 may be in a network node containing an MIB, and a database 130 may be the repository of the copied or derived representation of the MIB data in the agent 120.

A manager 110 may contain three modules—a polling-based synchronizer 112, an event-driven synchronizer 114, and a synchronization manager 116. As noted above, in polling-based synchronization the manager 110 may request updates 122 from an agent 120 when an update is needed, and in event-driven synchronization an agent 120 may send an event to a manager 110 every time a new update occurs.

Polling based synchronizer 112 may manage polling-based synchronization tasks in SNMP, and may respond to commands sent using synchronization messages 138 (described further below) received from the synchronization manager 116 to modify polling configurations such as the length of each polling period, which variables may be polled, which agents may be polled, etc. For example, polling based synchronizer 112 may send SNMP GetRequest or GetNextRequest messages 122 to an agent 120 when a manager 110 needs an update and handle the response 124 sent by the agent 120, which may be in the form of an SNMP Response message 124. Polling based synchronizer 112 may handle one or more responses 124 by sending to a database 130 updates 134 received and compiled during polling based synchronization.

Event-driven synchronizer 114 may manage event-driven synchronization tasks using standard SNMP messages as well as respond to commands sent using synchronization messages 142 (described further below) received from the synchronization manager 116 to alter synchronization parameters such as changing the size of event buffers, stop handling events (preparatory to changing to polling based synchronization), etc. For example, Event-driven synchronizer 114 may receive InformRequest messages 128 and in response to each send a confirmation message 126 that the message 128 was received. In addition, Event-driven synchronizer 114 may send to a database 130 updates 136 received and/or compiled during event driven synchronization.

Synchronization manager 116 may manage the synchronization by, for example, monitoring the number of messages received by manager 110, sending parameter messages 138, 142 to the polling based synchronizer 112 and event-based synchronizer 114 to modify synchronization configurations, and sending synchronization type (event-driven or polling), variables, and thresholds to one or more agents 120 using extended SNMP messages 132. Synchronization manager 116 may be configured with synchronization policies via a user interface, a configuration file, or by an automatic process.

Event-driven synchronization is described herein in more detail than polling-based synchronization. Additional possible configurations for synchronization are described in co-pending application U.S. application Ser. No. ______, filed on same date herewith, Attorney Docket Number ALC 3920, “Polling Based Synchronization in Managed Networks,” which as noted above is incorporated by reference for all purposes as if fully set forth herein.

As noted above, event-driven synchronization requires fewer networking and processing resources, but can result in over-utilization in manager resources when large numbers of update messages arrive in a short period of time. Therefore, a key requirement to preserve the benefits of event-driven synchronization over known configurations but nevertheless reduce the strain on system infrastructure is to reduce the number of messages exchanged between the manager and the agent so as to reduce the consumption of computational resources of the agent and the manager and decrease synchronization delays.

As discussed, SNMP protocols allow both acknowledged and unacknowledged asynchronous notification from agent to manager using, respectively, InformRequest and Trap messages. Event-driven synchronization may be characterized by which of these message types is used to communicate updates. In event-driven synchronization based on unacknowledged SNMP notifications (SNMP traps), an agent 120 may send SNMP notifications (or traps) 128 to a manager 110 to provide notification of variable updates. Because the SNMP notifications 128 are not confirmed, no confirmation message 128 is sent, and thus there is a greater chance that a notification 126 may be lost in the network without arriving to the manager and without being re-sent. In event-driven synchronization based on SNMP Inform messages, an agent 120 may send SNMP inform messages 128 to a manager 110 to provide notification of variable updates. Because SNMP protocol states that Inform messages should be confirmed, manager 110, through event-driven synchronizer 114, may reply with a confirmation message 126 to the agent 120 that sent message 128. Although SNMP protocol specifies that a confirmation message 126 should be sent upon receipt of an Inform message 128, SNMP does not require retransmission of messages when a confirmation message is not received—thus, if an agent 120 fails to receive a confirmation message 126 in response to an inform message 128, it may be determined that message 128 was lost, but nevertheless message 128 may not be re-transmitted. However, if a confirmation message 126 is received, it may be determined that message 128 was received.

Sending additional confirmation messages consumes additional resources, so in order to reduce the number of messages sent through the system, in many cases it may be preferable to send update messages between the agent and the manager using SNMP Trap messages. However, because SNMP notifications are not confirmed, event-driven synchronization based on SNMP notifications should be used carefully; event-driven synchronization based on SNMP inform messages may be preferred for critical situations where the manager should be updated with a greater degree of certainty. In some situations, rather than sending an acknowledgement for every Inform message that is sent, acknowledgement may be sent for a group of a modified Inform messages.

So that agents and managers may track what methods may be used to synchronize data so that messages between them, a Synchronization MIB may be defined that may maintain information about the type of adaptive synchronization methods are available in each agent, enabling event-driven and polling based synchronization between agent and manager. The Synchronization MIB may be optional, but may be required for an agent to support event-driven synchronization. As mentioned above, the current SNMP protocol already includes an MIB, so a Synchronization MIB may be implemented using definitions already within the standard. Although the SNMP standard does not identify rows using an OID, for the purpose if identifying a row in an SNMP table the OID of the first attribute in the table entry may be used because it contains the table OID and the row index part (for example, the format of OID of an attribute with <attr index> in a table row may be: <table entry OID> followed by <attr index> followed by <row index>—thus the <table entry OID> and <row index> may be used to identify each row. SEQUENCE, INTEGER and OID (object identifier) are types already defined within the SNMP protocol. Thus, data elements within a Synchronization MIB may be created according to the specification for these types. Each Synchronization MIB may contain at least one syncTable, a SEQUENCE of syncEntry that may represent the Synchronization table, and a syncNumber, an INTEGER that may represent the number of entries in the syncTable. Before sending a Sync-TableColumn request to the SNMP agent, a manager may walk through a copy of the agent's Synchronization MIB located remotely or in proximity to the agent in order to discover for which table rows or table columns the agent is keeping synchronization information.

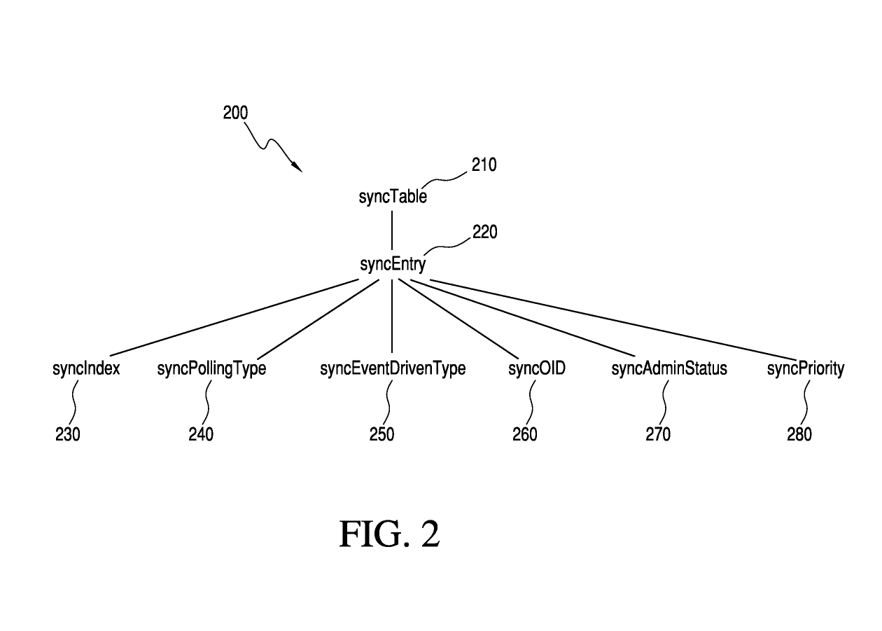

FIG. 2 illustrates an exemplary structure of a syncTable 210 that may have an OID and may represent the Synchronization MIB 200 that may be resident in an agent 120. One example of a syncEntry 220 as an entry in syncTable 210 may be a type of SEQUENCE having an OID, and may describe the synchronization monitoring of a table row or table column corresponding to an object or variable relevant to manager 110. Each syncEntry 220 may contain at least the following objects and/or variables: a syncIndex 230 which may have an OID and may be an index assigned by the agent 120 to uniquely identify syncEntry 220 in syncTable 210 (in certain data constructs, the syncEntry may designate the row of syncEntry 220); a syncPollingType 240 may be an integer representing which type of polling based synchronization is supported by the agent, where 0 is not supported, 1 is none, 2 is time-based, 3 is window based, and 4 and higher may indicate support for additional techniques or other options; a syncEventDrivenType 250 may be an integer representing which type of event-driven synchronization is supported by the agent, where 0 is not supported, 1 is none, 2 is Trap-based (SNMP notification); 3 is Inform-based (SNMP Inform), and 4 and higher may indicate support for additional congestion-management techniques or other options as may be described herein; a syncOID 260 may be an OID of the table column or table row for which the synchronization value may be kept; a syncEventThreshold (not shown) may be an integer representing how many updates are necessary before the agent sends a synchronization event, which may be dependent upon the specification of the type of synchronization indicated in syncEventDrivenType; a syncAdminStatus 270 may be an integer representing a synchronization status of the syncEntry 220, where 1 may be up or active, and 2 may be down or non-active; and a syncPriority 280 may be an integer representing a priority class of the update to be sent to the manager, which may have any range from a low number such as 0 designating high priority to any higher integer designating low priority—depending on the complexity of the system, for example, from 10 to 100 or more priority classes may be established, where the priority may be set by the manager to define the relative importance of various events—for example, a manager might designate that a hardware failure condition has a higher priority than a status change of some interface.

A manager may have write access to an agent's Synchronization MIB 200 to add or delete definitions in the synchronization table 210. The values of syncPollingType 240 and syncEventDrivenType 250 are independent, but each indicates the method used by the agent and manager to synchronize their MIBs. Table 1 demonstrates possible combinations of values for these variables, and the effect of these combinations on the agent and manager:

| syncPollingType | syncEventDrivenType | Action |
|---|---|---|
| 0, 1 | 0, 1 | No synchronization collaboration between agent and |
| | | manager. |
| 0, 1 | 2, 3 | Only event-driven synchronization between agent and |
| | | manager. An SNMP notification (where |
| | | syncEventDrivenType = 2) or an SNMP inform (where |
| | | syncEventDrivenType = 3) is sent every time the number |
| | | of updates reaches syncEventThreshold since the last |
| | | time such synchronization event was sent. |
| 2, 3 | 0, 1 | The manager may interrogate the agent for updates. |
| | | Events are not sent to the manager automatically by the |
| | | agent when an update happens. The agent may keep time |
| | | (where syncPollingType = 2) or an update window (where |
| | | syncPollingType = 3). |
| 2, 3 | 2, 3 | An SNMP notification (where syncEventDrivenType = 2) |
| | | or an SNMP inform (where syncEventDrivenType = 3) |
| | | may be sent every time the number of updates reaches |
| | | syncEventThreshold since the last time such |
| | | synchronization event was sent or since the last time the |
| | | manager the manager interrogated the agent for an update |
| | | of the variable being altered. |

Where both the agent and the manager support event-driven or polling based synchronization, they may implement adaptive synchronization as described herein. In order to maximize the flexibility of the management system 100 with regards to legacy or non-extended SNMP devices, agents such as agent 120 may not be required to enable either polling based or event-driven synchronization, but if they do, in order to implement adaptive synchronization an agent or manager will include the ability to process extended Synchronization PDUs.

As can be seen above, where adaptive synchronization is not implemented it may be expected that syncPollingType 240 or syncEventDrivenType 250 should have the value 0 to designate that polling based or event-driven synchronization is not supported, respectively. However, the system may be flexible enough to handle situations where an agent that does not implement adaptive synchronization also does not have extended SNMP capabilities as described herein, for example, by sending an error message in response to extended SNMP synchronization requests from a manager to an unextended agent. Thus, as an example, if a manager attempts to set syncPollingType in the agent, an SNMP response message with an SNMP error code may be returned, such as SNMP_ERRORSTATUS_NOSUCHNAME; and a similar error code may be returned by an agent not implementing event-driven synchronization if a manager attempts to set syncEventDrivenType in the agent. On the other hand, if adaptive synchronization is implemented in both the manager and the agent, but a specific type of polling based synchronization (syncPollingType=2,3, etc.) or event-driven synchronization (syncEventDrivenType=2,3,4,5, etc.) is not implemented, the agent may not change its current value and may instead send an SNMP response back to the manager with an SNMP error such as SNMP_ERRORSTATUS_WRONGVALUE.

In order to minimize the number of requests for additional information sent from a manager 110 to an agent 120, it may be preferable for an agent to be aware of these dependencies. So that an agent may track which objects and properties a manager considers related, such that when one object or property is updated the manager is notified of the status of all of the related objects or properties, a Synchronization Dependency MIB may be defined that may maintain information about relationships between objects and properties, enabling event-driven synchronization between agent and manager. A Synchronization Dependency MIB may be optional, but when implemented, it may describe dependencies between table columns or table rows monitored through a Synchronization MIB. A Synchronization Dependency MIB may be implemented using definitions already within the SNMP standard, such as SEQUENCE, INTEGER and OID (object identifier) which are types already defined within the SNMP protocol.

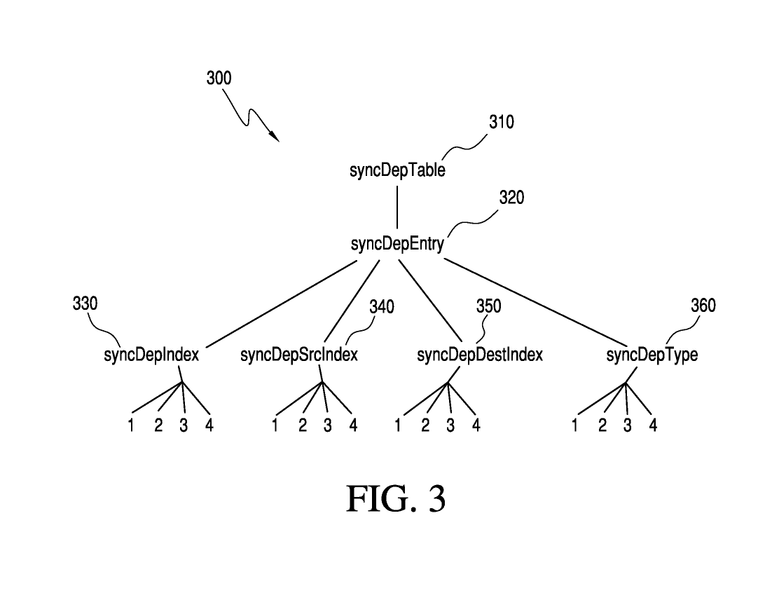

FIG. 3 illustrates an exemplary structure of a Synchronization Dependency MIB 300. A Synchronization Dependency MIB 300 may include a syncDepTable 310 and a syncDepNumber (not shown). syncDepTable 310 may include a SEQUENCE of syncDepEntry 320 that may contain the dependency relations recorded in Synchronization Dependency MIB. syncDepNumber may be an integer representing the number of entries such as syncDepEntry 320 in syncDepTable 310. Each syncDepEntry 320 may include at least the following objects and/or variables: a syncDepIndex 330 which may have an OID and may be an index assigned by the agent to uniquely identify syncDepEntry 320 in syncDepTable 310 (in certain data constructs, the syncDepIndex 330 may designate a row of syncDepEntry 320 in the Synchronization Dependency table syncDepTable 310); a syncDepSrcIndex 340 may be an index of the entry in the Synchronization Table (syncIndex) 210 for which the table column synchronization is kept; a syncDepDestIndex 350 may be an index of the entry in the Synchronization Table (syncIndex) 210 for which the column table pointed to by syncDepSrcIndex depends; and a syncDepType may be an integer representing a type of the dependency, where 1 is “value-match,” such that the syncDepDestIndex of elements of the destination set (resulting set) must match the syncDepSrcIndex of the elements of the source set, and 2 is “any,” such that the destination set may not depend on matches with the source set.

Where both are implemented, together the Synchronization MIB 100 and Synchronization Dependency MIB 200 may determine a graph of dependencies, where the graph vertexes may be determined by the values in the columns syncDepSrcIndex 340 and syncDepDestIndex 350, and where each graph edge may correspond to a dependency relation indicated in a table row syncDepEntry 320 in syncDepTable 310. To illustrate such a dependency graph, an exemplary syncTable which may represent syncTable 210 may be:

| | | | | |
|---|---|---|---|---|
| syncIndex | syncPollingType | syncEventDrivenType | syncOID | syncAdminStatus |

| | | | |
|---|---|---|---|
| S1 | 2 | 0 | ifOperStatus |
| S2 | 2 | 3 | ipAddressAddr |
| S3 | 2 | 0 | ipForwardDest |
| S4 | 2 | 0 | ospfIfState |
| S5 | 2 | 3 | ifAdminStatus |

and an exemplary syncDepTable which may represent syncDepTable 310 may be:

| syncDepIndex | syncDepSrcIndex | syncDepDestIndex | syncDepSrcMatch | syncDepDestMatch | syncDepType |
|---|---|---|---|---|---|
| SD1 | S1 | S2 | ifIndex | ipAddressIfIndex | 2 |
| SD2 | S1 | S3 | ifIndex | ipForwardIfIndex | 2 |
| SD3 | S2 | S4 | | | 1 |
| SD4 | S5 | S1 | ifIndex | ifIndex | 2 |

In a syncTable such as syncTable 210, each entry may indicate how synchronization is done for each object identified by syncOID 260. A syncDepTable such as syncDepTable 310 may indicate the dependencies between objects in syncTable 210. Rows in syncDepTable 310 may be represented by syncDepEntry 320. The columns syncDepSrcIndex 340 and syncDepDestIndex 350 in each syncDepEntry 320 are syncIndex 230 values taken from syncTable 210. For example, a syncDepEntry 320 may contain the value sᵢ for syncDepSrcIndex 340 and the value dᵢ for syncDepDestIndex 350, where the row corresponding to syncDepEntry 320 may describe a dependency between a row (e.g. syncEntry 220) in syncTable 210 whose syncIndex 230 is sᵢ and another syncEntry 220 in syncTable 210 whose syncIndex 230 is dᵢ. As a specific example, in the second row SD2 of the syncDepTable above, the value S1 in syncDepSrcIndex and value S3 in syncDepDestIndex together indicate a dependency between objects ifOperStatus (corresponding to syncIndex=S1) and ipForwardDest (corresponding to syncIndex=S3).

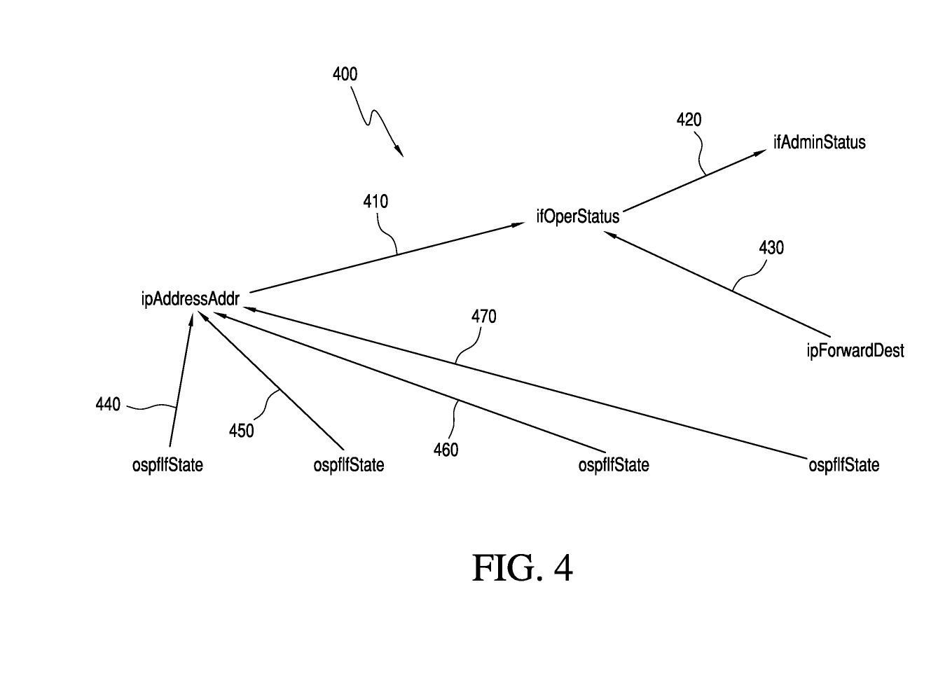

FIG. 4 illustrates an exemplary directed graph 400 of dependencies corresponding to the combined entries S1-S5 and SD1-SD4 of exemplary syncTable and syncDepTable above. Each pair of syncDepSrcIndex, syncDepDestIndex values in any row of syncDepTable determines an edge 410-470 on graph 400. For example, the previous dependency SD2 between ifOperStatus (syncIndex=S1) and ipForwardDest (syncIndex=S3) is described by the edge 430 whose vertexes are ifOperStatus and ipForwardDest. In a further example, there may be multiple values for ospfIfState, and as shown in edges 440, 450, 460, and 470 and described in the dependency SD3 between ipAddressAddr (syncIndex=S2) and ospfIfState (syncIndex=S4). Finally, it may be seen that edges 410 and 420 correspond to syncDepTable entries SD1 (dependency between ifOperStatus (syncIndex=S1) and ipAddressAddr (syncIndex=S2)) and SD4 (dependency between ifAdminStatus (syncIndex=S5) and ifOperStatus (syncIndex=S1)), respectively.

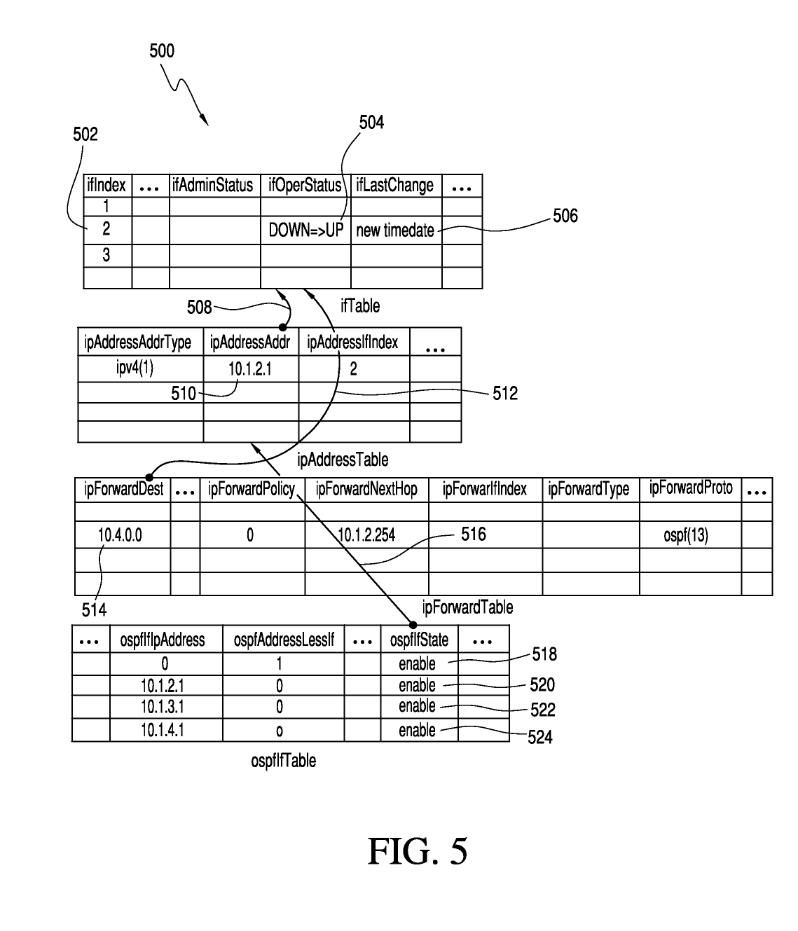

FIG. 5 illustrates an exemplary minimum spanning tree 500 demonstrating the effect of an update on other objects in a network environment. Each time an object corresponding to a syncEntry 220 on a syncTable 210 is updated, a minimum spanning tree may be generated whose vertexes are objects in the network environment upon which the updated object may have some effect as determined by syncDepTable 310. The root of the minimum spanning tree may be the object being updated, and the other (non-root) vertexes may be connected through edges which are associated to dependencies in syncDepTable 310. For example, in minimum spanning tree 500, it may be seen that in row 502 corresponding to Interface 2 (ifIndex=2), the value of ifOperStatus 504 in the ifTable may change from “DOWN” to “UP,” triggering the following updates: a new time and date 506 in value ifLastChange in the ifTable (note that there is no dependency for ifLastChange recorded in the syncDepTable, as discussed below); the dependency 508 corresponding to the dependency SD1 between ifOperStatus S1 in the ifTable and ipAddressAddr S2 causing a new entry in table ipAddressTable including ipAddressAddr 510; the dependency 512 corresponding to the dependency SD2 between ifOperStatus S1 in the ifTable and ipForwardDest S3 in the ipForwardTable causing a new entry in table ipForwardTable created to add a new route for the updated interface corresponding to ifIndex 2, including a value for ipForwardDest 514; the dependency 516 corresponding to the dependency SD3 between ipAddressAddr S2 in the ipAddressTable and ospfIfState S4 in the ospfIfTable causing a status change to “UP” in the ospfIfState values of the entries corresponding to the OSPF Interface with address 0 518, the OSPF Interface with address 10.1.2.1 520, OSPF Interface with address 10.1.3.1 522, and the OSPF Interface with address 10.1.4.1 524. For purposes of this illustration, the effect on ifAdminStatus illustrated by dependency SD4 is not shown.

As discussed above, in order to implement adaptive synchronization an agent or manager will include the ability to process extended Synchronization PDUs, and for dependency operations this may include PDUs designating which objects and properties are related. For example, in order to send information about multiple related updates affected by the update of a single object or property, an “objectUpdate” notification message may be defined as a PDU which may be sent by an agent as a Trap or an Inform to a manager to indicate that updates have occurred in the agent's MIB. Rather than identifying a single object, there may be a varibind list that follows the format described in the protocol for GetResponse messages for Sync-TableColumnRequest and Sync-TableRowRequest—note that the current version of RFC 3416 section 4.2.6 allows that additional objects be included, but not specified in the OBJECTS clause. An exemplary definition of objectUpdate may be:

```
objectUpdate NOTIFICATION-TYPE
    STATUS current
    DESCRIPTION
        “A objectUpdate notification signifies that the SNMP entity,
        acting in an agent role, has detected that an update in its MIB
        objects. The varbind list should follow the format described
        for GetResponse PDU for Sync-TableColumnRequest and
        Sync-TableRowRequest PDUs”
::= { syncNotificationPrefix 1 } .
```

In addition to “objectUpdate” notification messages, additional notification messages “objectDelete” and “objectAdd” may be added as additional PDUs to communicate object deletion and creation.

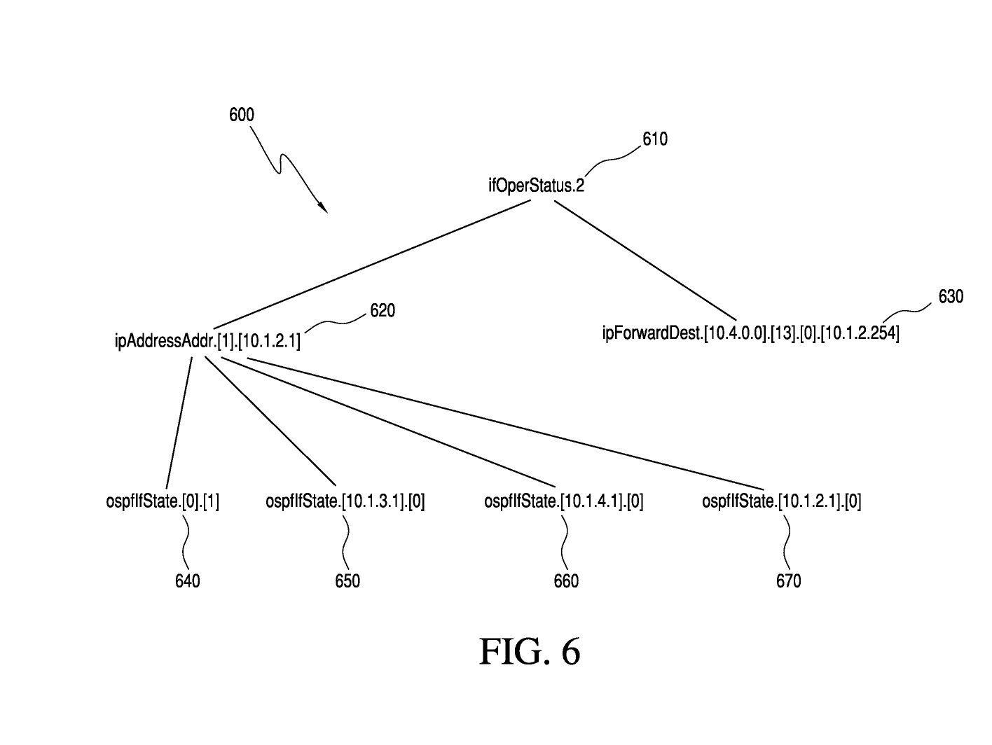

FIG. 6 illustrates an exemplary graph 600 of the update corresponding to the update illustrated in the minimum spanning tree 500. This graph 600 may correspond to a message 128 that an agent 120 may send to the manager 110 to notify the manager of an update. For example, after an update of ifOperStatus 610 is complete, the agent 120 may send an SNMP Trap or Inform message whose varibind list contains the varibinds ifOperStatus.2 610, ipAddressAddr.[1].[10.1.2.1] 620, ipFowardDest.[10.4.0.0].[13].[0].[10.1.2.254] 630, ospfIfState.[0].[1] 640, ospfIfState.[10.1.2.1].[0] 670, ospfIfState.[10.1.3.1].[0] 650, and ospfIfState.[10.1.4.1].[0] 660. Because no dependency for ifLastChange is recorded in the syncDepTable above, the change of this variable will not be included in the varbind list even though a change to the variable was triggered by the change 504 to the variable ifOperStatus.

### Congestion Control for Event-Driven Synchronization

Even though event-driven synchronizations may require of the manager less usage of networking and utilization of processing resources than polling based synchronization, in event-driven synchronization the arrivals of large numbers of updates in a short period of time may stress the manager. The event buffer size of the manager is limited whether used for traps or informs. When large numbers of updates are received, messages may become congested if the manager's event buffer becomes overloaded, and if this happens, event notifications such as updates may be discarded. The manager may later trigger additional transactions to recover information lost due to event discards. Event buffer overflow in the manager may be aggravated by event-driven synchronization using the proposed Synchronization Dependency MIB 300. Although the dependency implementation may be expected to result in a desirable reduction of the overall number of transactions passed between the agent and the manager, the transmission of multiple dependencies at a time may result in a need for the manager to receive more PDUs in its network buffers at a time. In some such instances, in conventional implementations the manager's event buffer may overload and increasingly discard notifications which may subsequently need to be retransmitted by the agent. Therefore, it would be preferable to avoid overloading the manager event buffer during event-driven synchronization.

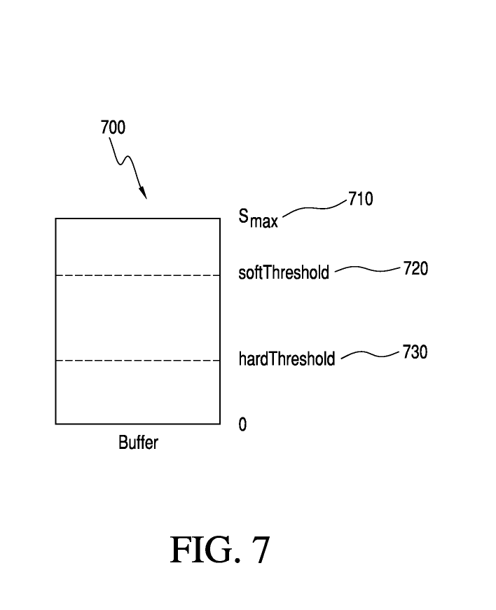

FIG. 7 illustrates an exemplary manager event buffer 700 as a data structure with the parameters sₘₐₓ 710, softThreshold 720, and hardThreshold 730, where sₘₐₓ 710 illustrates the size of the entire event buffer, softThreshold 720 represents an amount of space available remaining in the buffer that illustrates a value that satisfies the condition: sₘₐₓ>softThreshold>hardThreshold, and hardThreshold 730 represents an amount of space available remaining in the buffer that illustrates a value that satisfies the condition softThreshold>hardThreshold. The occupancy of the manager's event 700 buffer may be managed by controlling the number of notifications exchanged between the manager and the agent and the maximum size of each notification. The values for buffer size sₘₐₓ 710, hardThreshold 730 and softThreshold 720 may be configuration parameters of managers and agents which may be configured via a user interface, configuration file, or other administration method, or may vary dynamically to adjust to network conditions according to a script or other method.

In some implementations, the event buffer may be mapped to the UDP receive buffer for ease of configuration. The size of the buffer may be altered by changing buffer size options, but will be restricted by the available size allocated to the buffer in the operating system.

A period of time when a manager 110 is congested because the number of bytes left in the buffer 700 is between hardThreshold 730 and softThreshold 720 may be called a “contention phase.” During a contention phase if the departing rate of notifications from the event buffer is greater than the arriving rate of notifications the buffer will be able to free additional buffer space to prepare for further bursts or for a normal rate of incoming messages. Where a_{B} is the arriving rate of notifications during a period and d_{B} is the departing rate of notifications during a period, the rate at which the management application consumes notifications from the event buffer, to end the contention phase the following condition must be reached: ∫ₜ₌ₜ_{₀}^{t}^{_{f}}(d_{B}−a_{B})dt>softThrehold—hardThreshold—in other words, the amount of space freed from the buffer must be greater than or equal to the difference between softThreshold and hardThreshold during the burst period (from tₒ to t_{f}). Thus, to avoid a buffer overrun where incoming notifications may be discarded, at least three adjustments may be made: 1) The difference of (softThreshold—hardThreshold may be increased; 2) the consuming rate d_{B} of the management application may be increased; and 3) the arriving rate of incoming messages a_{B} may be decreased. The first adjustment depends upon the amount of memory dedicated to the event buffer 700, which may be changed by adding additional memory (hardware) and/or reallocating existing memory. The second adjustment depends upon system resources such as CPU time, memory, parallel I/O, etc. which are dedicated to the management application—additional resources allocated to the management application may at least partially increase the consumption rate of the management application. The manager 110 and agent 120 may also coordinate to decrease the arrival rate of notifications a_{B}.

So that agents and managers may communicate about the condition of the manager's event buffer 700, an Event Buffer MIB may be defined that may contain information about manager event buffer parameters used by the agent to control message congestion at the manager. The variables in this MIB may be carried on notifications exchanged between agent and manager.

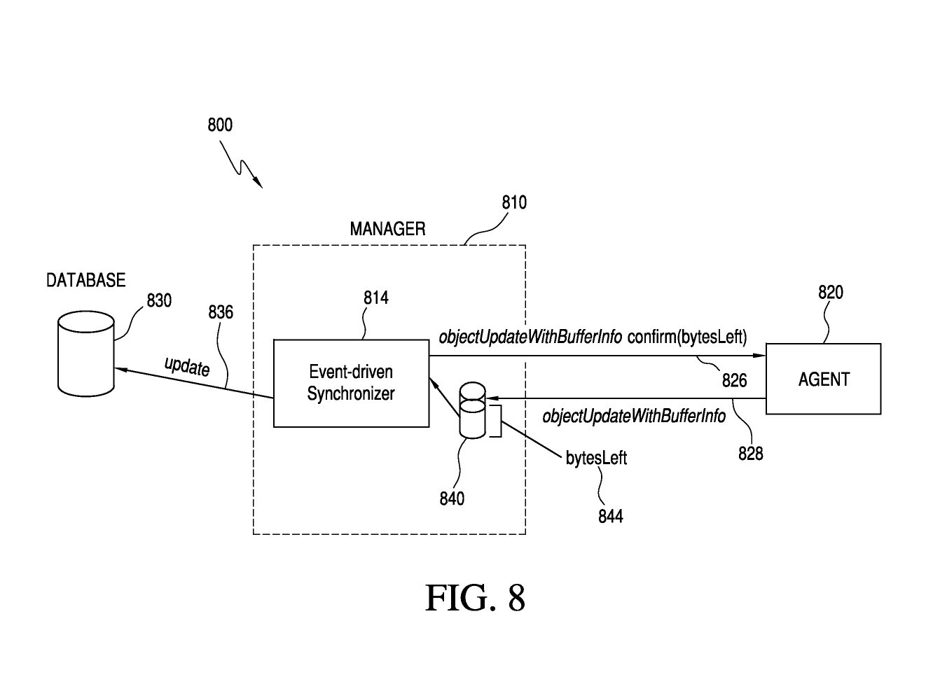

FIG. 8 illustrates a simplified, exemplary and generic system 800 in which congestion control messages may be exchanged between a manager 810 and an agent 820. Manager 810 may correspond to the manager 110 and agent 820 may correspond to the agent 120. Buffer 840 may correspond to manager event buffer 700. An Event Buffer MIB (not shown) may be optional, but may be required for an agent to support congestion control for event-driven synchronization. An Event Buffer MIB may be implemented using definitions already within the SNMP standard, such as SEQUENCE, INTEGER and OID (object identifier) which are types already defined within the SNMP protocol. The Event Buffer MIB may include at least the following defined objects and/or variables: a syncMgmtEventBufferSize may be an integer indicating the total size (sₘₐₓ 710) of the manager event buffer 840 in bytes; a syncMgmtEventBufferHardThreshold may be an integer indicating the designated size of the manager event buffer 840 hardThreshold value 730 in bytes; a syncMgmtEventBufferSoftThreshold may be an integer indicating the designated size of the manager event buffer 840 softThreshold value 720 in bytes; a syncMgmtEventBufferBytesLeft may be an integer indicating amount of capacity remaining 844 in the manager event buffer 840, expressed in bytes; and a syncMgmtMaxPriorityNotification may indicate a value of syncPriority for the corresponding syncEntry for each variable (varibind) in a potential notification, where if the corresponding syncEntry for any variable contains a syncPriority greater than the value of syncMgmtMaxPriorityNotification, the manager 810 may discard the whole notification and in the case of a discard no notification confirm message will be sent to the agent 820.

The syncMgmtEventBufferBytesLeft variable indicating in the Event Buffer MIB on the agent how many bytes are left 844 in the manager's event buffer 840 may be updated by the manager in a value included in an SNMP Notification Confirm message 826 sent back to the agent 820 in response to an update message 828 sent to manager 810 an handled by Event-driven synchronizer 814. A new type of SNMP Notification message “objectUpdateWithBufferInfo” 826 may be defined to carry from the agent 820 to the manager 810 an additional variable designating a need for updated buffer information. An exemplary definition of objectUpdateWithBufferInfo may be:

```
objectUpdateWithBufferInfo NOTIFICATION-TYPE
    OBJECTS { syncMgmEventBufferBytesLeft }
    STATUS current
    DESCRIPTION
        “A objectUpdate notification signifies that the SNMP entity,
        acting in an agent role, has detected that an update in its MIB
        objects. The varbind list should follow the format described
        for GetResponse PDU for Sync-TableColumnRequest and
        Sync-TableRowRequest PDUs”
::= { syncNotificationPrefix 2 } .
```

As may be seen in FIG. 8, a confirm message 826 sent in response to a objectUpdateWithBufferInfo message 828 may send an variable value indicating the bytes left 844 in the manager's event buffer 840.

Where a manager 810 and agent 820 are able to communicate about the state of the buffer 840, proactive actions may be taken to avoid subsequent buffer overload. A manager 810 may ask one or more agents 820 with which it communicates to proactively switch from event-driven synchronization to polling based synchronization when the event buffer 840 is in danger of becoming overloaded—during polling based synchronization the manager 810 may poll the agent 820 to keep updated at a pace that does not risk event discards. Rather than switching to polling based synchronization, as the buffer approaches congestion the agent may proactively slow down the rate at which it sends updates in order to give the manager time to process the glut of notifications in the buffer. The sending rate may be based upon, for example, the occupancy and, in the case where notifications are confirmed, the round-trip time between when notifications are sent and when notification confirmations are received.

The manager 810 and agent 820 may make independent decisions based upon the amount of usage or congestion at the manager 810 as indicated by the amount of memory used and available in the buffer 840.

For example, if the amount of space available 844 in the buffer 700/840 is greater than softThreshold 720, the manager 810 may continue to receive notifications normally without taking any action to prevent congestion. However, if the amount of space available 844 in the buffer 840 is less than softThreshold 720, but greater than hardThreshold 730, the manager may indicate to the agent by sending with a notification confirmation 826 an indication that the number of bytes left in its buffer 844 is equal to or less than hardThreshold, which may prompt the agent to reduce the maximum notification size sent by the agent and decrease its sending rate, which would allow the manager additional resources to process the backlogged notifications in its buffer 840.

If the amount of space available 844 in the buffer 840 is less than hardThreshold 730, the manager 810 may send a notification indicating the amount of bytes left in its buffer 844 and that the agent should temporarily change the synchronization type of at least some variables to polling based synchronization so the agent 820 does not send notifications 828 about updates to those variables except upon request by the manager 810. The change may be communicated from the manager 810 to the agent 820 by SNMP request message as described below. Once the congestion clears and the bytes left 844 in the buffer 840 increases beyond softThreshold 720, the manager may communicate to the agent to return the synchronization types for those variables to event-driven synchronization. Although the manager 810 and agent 820 may communicate about the buffer size, they independently implement changes to buffer size.

To temporarily switch from event-driven to polling based synchronization, the manager 810 may invoke a procedure “temporarySwitchAgentSyncronizationToPolling( )” that may send an SNMP Set-request to the agent 820 to decrease the value of the variable “syncMgmtMaxPriorityNotification” stored in the Event Buffer MIB in the agent 820. Even during event-driven synchronization, an agent 810 may not include variables that have a Synchronization MIB 200 syncPriority value 280 greater than syncMgmtMaxPriorityNotification when constructing update notifications, unless it receives a specific request from the manager 810 to do so. Because messages will be smaller, and fewer updates will be sent (because the changes for some variables will not be communicated in update messages) the amount of storage consumed in the manager's event buffer 840 will be reduced. In order to minimize constant switching back and forth between polling based and event-driven synchronization, the procedure temporarySwitchAgentSyncronizationToPolling( ) may monitor the event buffer 840 and not send an update increasing the value of syncMgmtMaxPriorityNotification so long as event buffer 840 has less than softThreshold 730 bytes left 844; when the number of bytes left in the buffer 844 is greater than softThreshold 730, the manager 810 may reset syncMgmtMaxPriorityNotification in the agent 820 to its previous value or to a default value by sending an SNMP Set-request to the agent 820 to increase the value of syncMgmtMaxPriorityNotification. Further, the manager 810 may delay sending the update resetting syncMgmtMaxPriorityNotification to the agent or agents 820, thus delaying propagation of the information that the event buffer 840 is below softThreshold to provoke a hysteresis effect and allow the buffer time to clear the burst of events before inviting an additional burst to clear backlogged updates. Further, a manager 810 may stagger sending a syncMgmtMaxPriorityNotification amongst various agents 820, so that bursts from multiple agents may be staggered.

An agent 820 may monitor relevant values for changes, and when one is detected, build a notification including the variable where the change is detected and any dependent variables as indicated by the Synchronization Dependency MIB 300. Once the notification is complete the agent 820 may determine the size of the notification and compare the size to the amount of bytes left in the buffer as sent by the manager 810. If the notification is larger than the size remaining in the buffer, the agent 820 may minimize the size of the notification by first stripping variables whose syncPriority value exceeds that of the syncMgmtMaxPriorityNotification value sent by the manager, and if the notification size still exceeds the remaining buffer capacity, stripping all but the information needed to communicate the sole updated variable. The agent 820 will then send the notification or minimized notification 828, and wait until it receives a confirmation message 826 which will confirm that the notification 828 was received and update the size of the buffer. If no confirmation message 826 is received before a designated timeout period, the agent may wait for a designated period of time and then retransmit the notification.

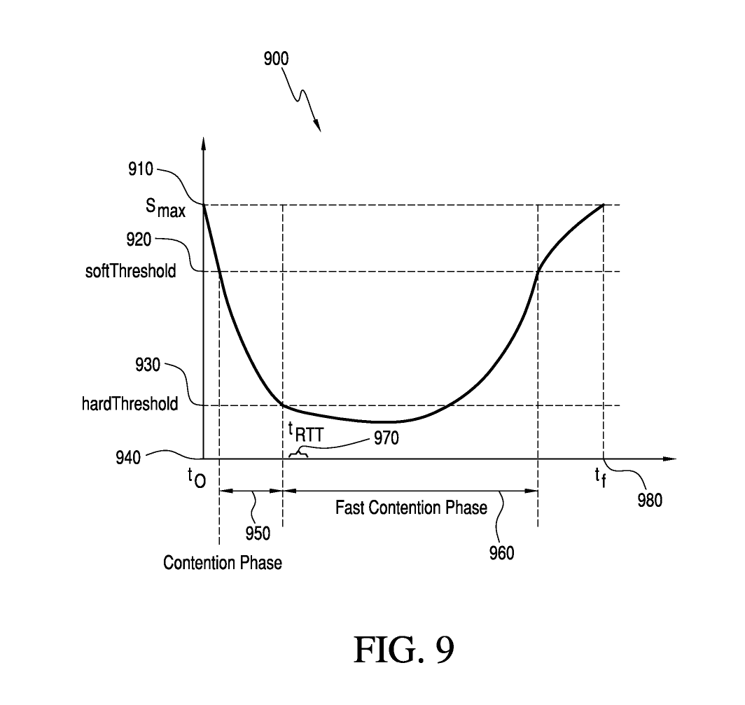

A period of time when the amount of space remaining in the buffer 840 falls below hardThreshold 730 may be referred to as a “fast contention phase.” FIG. 9 illustrates a graph demonstrating buffer use during an exemplary period from t₀ 940 to t_{f} 980 including contention phase 950 and fast contention phase 960. sₘₐₓ 910, softThreshold 920, and softThreshold 930 may correspond to sₘₐₓ 710, softThreshold 720, and softThreshold 730. During a fast contention phase 960, in order to clear or free space in the buffer 840 the departing rate of notifications from the event buffer d_{B} must be greater than the arriving rate of notifications a_{B}. Although some savings may be achieved by limiting the variables that are sent by the agent 820 in each PDU as described above, during any event-driven synchronization the agent 820 may still transmit notifications with a minimum notification size, which during a fast contention phase 960 may overwhelm the buffer 840. To achieve a state where the buffer 840 is not in danger of being overwhelmed by notification bursts, the manager may request the agent to temporarily switch to polling based synchronization by a procedure that may be referred to as “temporarySwitchAgentSyncronizationToPolling( )”.

In temporarySwitchAgentSyncronizationToPolling( ) manager 810 may send an SNMP SetRequest to an agent 820. A message takes some time to reach the agent 820 and take effect so that no additional event-driven messages sent from the agent 820 reach the manager 810. This time may be referred to as the round-trip time for a SNMP Set message (t_{RTT}) 970. During a burst where an agent 820 is sending many event-driven messages 828 to a manager 810, the time taken for the SNMP Set message to reach the agent 820 may be may be estimated to be approximately half of t_{RTT}. 970, and the next event-driven notification 828 sent to the manager 810 before the switch to polling takes effect may be predicted to take the remaining half of t_{RTT}. time 970 to reach the manager (not considering processing time spent by the manager and agent to handle the SNMP set request/replies and SNMP notification/confirms).

The manager 810 and agent 820 implement synchronization independently, but the messages communicated between them about the size of the buffer influences their respective behavior. The buffer size s_{MAX} 710 is a parameter that may be determined by the manager operating system, the softThreshold 720 and hardThreshold 730 are parameters that may be controlled by a congestion control algorithm at the manager 810, and syncMgmtMaxPriorityNotification is a parameter that may be adapted at the management system level. The number of notifications with size l_{MIN} sent during a fast contention phase 960 is dependent on the value syncMgmtMaxPriorityNotification in the agent's Event Buffer MIB. A low value for syncMgmtMaxPriorityNotification should decrease the number of l_{MIN}-sized notifications during the fast contention phase 960, but may also result in more variables to be synchronized by the temporarySwitchAgentSyncronizationToPolling( ) procedure using polling-based synchronization.

Although the manager and the agent may implement synchronization independently, the minimum decrease l_{MIN} may be achieved by selecting and sending to the agent 820 an appropriate syncMgmtMaxPriorityNotification value. During a fast contention phase 960, temporarySwitchAgentSyncronizationToPolling( ) may communicate to the agent to hold the variable synchronizations whose priority is greater than syncMgmtMaxPriorityNotification while some minimum communication (with notifications having size l_{MIN}) 828 still occurs so that the agent 820 may receive updates of the manager's buffer occupancy 844 piggy-backed in the notification confirmation(s) 826. Once the manager has processed most of the events in the buffer and therefore reduced its size and increased its available capacity 844, the agent 820 may receive a new value of the buffer size 844 from the manager 810 piggy-backed in the next notification confirmation(s) 826 sent from the manager 810 to the agent 820. The manager 810 may also exit the procedure temporarySwitchAgentSyncronizationToPolling( ) and communicate to the agent 820 permission to return to full event driven notification.

Note that although the congestion control procedures have been described with regards to updates, methods for controlling the impact on the event buffer may be extended for use in the congestion control for any notification by piggy-backing in any notification exchanged between agent and manager a variable such as syncMgmEventBufferBytesLeft, as is allowed in the definition of the NOTIFICATION-TYPE macro in the SMI definition. In the alternative, rather than using a procedure such as temporarySwitchAgentSyncronizationToPoiling( ), the variable syncMgmEventBufferBytesLeft may be delivered in every communication and ignored when it is not needed. Finally, although the methods have been described using inform messages with return confirmations in a synchronous communication, asynchronous communication of the same information may be possible using request messages without confirmations in two-way unacknowledged communications.

According to the foregoing, various exemplary embodiments provide for reduction of the resources needed to synchronize data in managed networks. In particular, by reducing the strain on the buffer in a manager through management of the number and size of messages incoming to the manager.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method for synchronizing data in a management database on a network node, the method carried out by an agent on the network, the method comprising:
storing an index associated with a relevant variable and a list of at least one indices associated with at least one dependency variables associated with the relevant variable;
detecting a status change in the relevant variable;
constructing an update notification comprising status information for the relevant variable and each of the at least one dependency variables; and
sending the update notification.

2. The method of claim 1 further comprising receiving a confirmation message in response to the update notification.

3. The method of claim 2 wherein the confirmation comprises a size limitation.

4. The method of claim 2 wherein the confirmation comprises an SNMP message.

5. The method of claim 1 wherein the update notification comprises an SNMP message.

6. The method of claim 1 further comprising designating a timeout period.

7. The method of claim 6 further comprising determining that the timeout period has expired;
determining that no confirmation has been received in response to the update notification; and
re-sending the update notification.

8. The method of claim 1 further comprising determining a size of the update notification;
determining the size of the update notification is greater than a size limitation; and
prior to the step of sending the update notification, modifying the update notification so the size of the update notification is less than the size limitation.

9. The method of claim 1 further comprising
determining a priority limit;
receiving a request to reduce update notifications;
constructing a second update notification comprising status information for the relevant variable and each of the at least one dependency variables;
calculating a priority of the second update notification;
comparing the priority of the second update notification with the priority limit;
determining the priority of the second update is greater than the priority limit; and
sending a notification of the second update.

10. The method of claim 9 further comprising:
determining the request to reduce update notifications comprises an update value for the priority limit; and
storing the new priority limit before the step of comparing the priority.

11. The method of claim 1 further comprising:
receiving a request to stop update notifications;
constructing one or more additional update notifications;
receiving an update request; and
sending the one or more additional update notifications.

12. A method for managing the synchronization of data in a management database on a network node, the method comprising:
receiving an update notification;
determining a buffer size;
calculating an amount of buffer remaining; and
sending an update notification confirmation, where the update notification confirmation comprises the amount of buffer remaining.

13. The method of claim 12 further comprising determining the amount of buffer remaining is greater than a soft threshold amount and less than a hard threshold amount; and
sending a request to reduce update notifications for one or more variables.

14. The method of claim 13, further comprising:
re-calculating the amount of buffer remaining;
determining the amount of buffer remaining is less than a soft threshold amount; and
sending a request to resume update notifications for the one or more variables.

15. The method of claim 14, further comprising:
determining a threshold delay timeout; and
prior to sending a request to resume update notifications, determining the threshold delay timeout has expired.

16. The method of claim 14 wherein the recalculated amount of buffer remaining is determined to be less than the previously calculated amount of buffer remaining minus the maximum size of a UDP header and a granularity divided by the number of messages in the buffer.

17. The method of claim 12 further comprising determining the amount of buffer remaining is greater than a hard threshold amount;
sending a notification to stop update notifications; and
requesting a second update notification.

18. The method of claim 17, further comprising:
re-calculating the amount of buffer remaining;
determining the amount of buffer remaining is less than a soft threshold amount; and
sending a notification to resume update notifications.

19. The method of claim 12 further comprising determining at least one dependent variable associated with a relevant variable; and
sending a message comprising an index associated with the relevant variable and a list of at least one indices associated with each of the at least one dependent variable.

20. The method of claim 19, wherein the message comprising an index comprises an SNMP message.
